(19) United States
(12) Patent Application Publication
(10) Pub. No.: US 2015/0116230 A1
(43) Pub. Date: Apr. 30, 2015

(54) Display Device and Icon Control Method Thereof

(71) Applicant: Inventec Appliances Corp., New Taipei City (TW)

(72) Inventor: Ming-Sen HSIAO, New Taipei City (TW)

(21) Appl. No.: 14/298,644

(22) Filed: Jun. 6, 2014

(30) Foreign Application Priority Data
Oct. 25, 2013 (TW) 102138721

(51) Int. Cl. G06F 3/0481; G09G 5/373; G06T 3/40; G06F 3/041

(52) U.S. Cl. CPC G06F 3/04817; G06F 3/0412; G09G 5/373; G06T 3/40
USPC 345/173

(57) ABSTRACT

A display device and an icon control method thereof are provided. A display device is prepared. The display device includes a touch panel and a control unit, and a first display area of the touch panel displays a first icon. When executing a command corresponding to the first icon, the control unit sends out a first activating signal. The control unit determines the number of times the first activating signal has been sent out, and then the control unit controls the display size of the first icon on the touch panel.

### CROSS-REFERENCE TO RELATED APPLICATION

This application claims the benefit of Taiwan Patent Application No. 102138721, filed on Oct. 25, 2013, which is hereby incorporated by reference for all purposes as if fully set forth herein.

### BACKGROUND OF THE INVENTION

1. Field of the Invention

The present invention relates to a display device and an icon control method thereof, and more particularly, to a display device and an icon control method capable of controlling the size and the display position of icons.

2. Description of the Prior Art

With the rapid advances in science and technology, new electronic gadgets are rapidly developed, which bring the convenience to people and enhance the people's quality of life. For example, the portable electronic devices such as personal computers (PC), personal digital assistants (PDA), smart phones, palmtops, and tablets, are created, which are light in weight and compact in size. Those electronic devices require an input device such as keyboard or mouse to input data or computer instruction; however, those input devices are typically cumbersome and sizeable; therefore, a touch panel of new generation input device has been widely applied to various electronic devices to replace conventional input devices. The new input device is composed of a touch panel and a display panel to form a touch display panel. The touch display panel of an electronic device has a touch area, and the touch area is corresponding to a display area of the touch display panel, so that a user may touch or slide on the touch area of the touch display panel by a finger or a stylus to activate any icons displayed on the touch display panel for executing a corresponding function.

Since the design of the latest electronic gadget is to pursuit lightweight and compact in size, the touch area of the touch display panel of an electronic device is usually limited within a certain size; therefore, it is quite inconvenient to control all the function icons displayed on the touch display panel in such a small area. As shown in FIG. 1, it is a top view of a conventional smart phone. The smart phone 900 includes a touch display panel 910. The touch display panel 910 displays a plurality of icons 911 which are arranged in a form of array, and each icon 911 has the same size.

When more and more icons 911 are displayed on the display area of the touch display panel 910, those icons 911 may be crowded together and hardly recognized by the user, and the user may easily touch an inaccurate icon, resulting in an inconvenience for users in aspect of use and control.

Therefore, a display device and a method capable of controlling icon sizes are needed in order to solve the above-mentioned problem.

### SUMMARY OF THE INVENTION

The object of the present invention is to provide a display device and a method capable of controlling icon sizes.

To achieve the above object, a display device is provided, and the display device of the present invention comprises a touch panel, used for displaying a first icon; a control unit, electrically connecting with the touch panel and used for sending out a first activating signal when the control unit executes a command corresponding to the first icon; and a counting unit, electrically connecting with the control unit and used for counting the number of times the control unit sends out the first activating signal, wherein the control unit controls the display size of the first icon on the touch panel based on the number of times the control unit sends out the first activating signal.

In one embodiment, the control unit enlarges the display size of the first icon on the touch panel when the number of times the control unit sends out the first activating signal is larger than a threshold value.

In one embodiment, the touch panel comprises a first display area and a second display area, the first icon is displayed on the first display area, and the control unit determines whether to move the first icon to the second display area based on the number of times the control unit sends out the first activating signal.

In one embodiment, the touch panel further comprises a second icon, when the control unit executes a command corresponding to the second icon, the control unit sends out a second activating signal, and the control unit controls the display size of the first icon or the second icon on the touch panel based on the number of times the first activating signal and the second activating signal have been sent out.

To achieve the above object, an icon control method is provided, which applies to a display device having a touch panel on which a first icon is displayed, a control unit, and a counting unit, and the method comprising steps of: sending out a first activating signal when detecting a command corresponding to the first icon being executed by the control unit; counting number of times the first activating signal sends out; and changing the display size of the first icon on the touch panel based on the number of times the first activating signal has been sent out.

In one embodiment, it further comprises a step of: enlarging the display size of the first icon on the touch panel when the number of times the first activating signal has been sent out is larger than a threshold value.

In one embodiment, when the touch panel further displays a second icon, the method further comprises steps of: sending out a second activating signal when detecting a command corresponding to the second icon being executed by the control unit; changing the display size of the first icon or the second icon on the touch panel based on the number of times the first activating signal and the second activating signal have been sent out.

In one embodiment, when the touch panel further comprises a first display area and a second display area, the method further comprises a step of: determining whether to move the first icon from the first display area to the second display area based on the number of times the first activating signal has been sent out.

In one embodiment, when the touch panel displays a second icon and further comprises a first display area and a second display area, and the first icon is displayed on the first display area and the second icon is displayed on the second display area, the method further comprises: sending out a second activating signal when a command corresponding to the second icon is executed by the control unit, and determining whether to move the first icon from the first display area to the second display area, or move the second icon from the second display area to the first display area based on the number of times the first activating signal and the second activating signal have been sent out.

The present invention further provides an icon control method, applied to a display device having a touch panel on which a first icon is displayed, a control unit, and a counting unit, and the touch panel further comprises a first display area and a second display area, and the first icon is displayed on the first display area, the method comprises steps of: sending out a first activating signal when detecting a command corresponding to the first icon being executed by the control unit; counting number of times the first activating signal has been sent out; and determining whether to move the first icon from the first display area to the second display area based on the number of times the first activating signal has been sent out.

The display device and the icon control method thereof may control the size of icons to have different display sizes based on the number of times they have been activated in order to achieve personalization. In the invention, based on the number of times the icon has been activated, a user may change the size and the display area of icons as he/she likes and thus to enhance the convenience in use. In addition, when an icon has been activated to a threshold value, the size of the icon may be enlarged and the icon may move to a display area on which the user may easily see and activate the icon next time.

### BRIEF DESCRIPTION OF THE DRAWINGS

The present invention will become more fully understood from the detailed description given herein below for illustration only, and thus are not limitative of the present invention, and wherein:

FIG. 1 is a top view of a conventional smart phone.

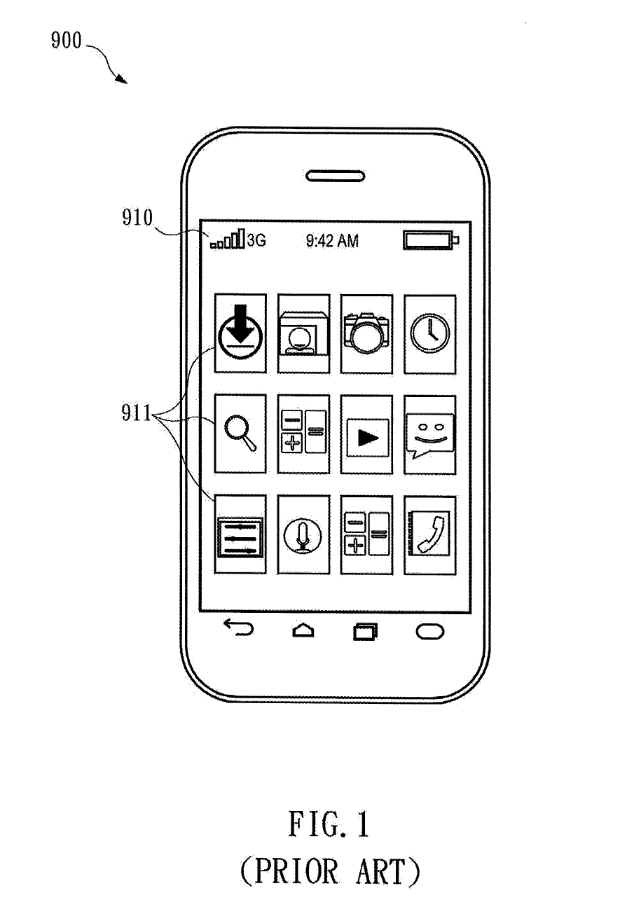

FIG. 2 is a block diagram of a display device according to an embodiment of the present invention.

FIG. 3 is a top view of a display device according to one embodiment of the present invention.

FIG. 4 is a flow chart of a control method according to an embodiment of the present invention.

FIG. 5 is a diagram showing a size and a position change of the first icon and the second icon.

FIG. 6 is a top view of a display device according to another embodiment of the present invention.

### DETAILED DESCRIPTION OF THE PREFERRED EMBODIMENTS

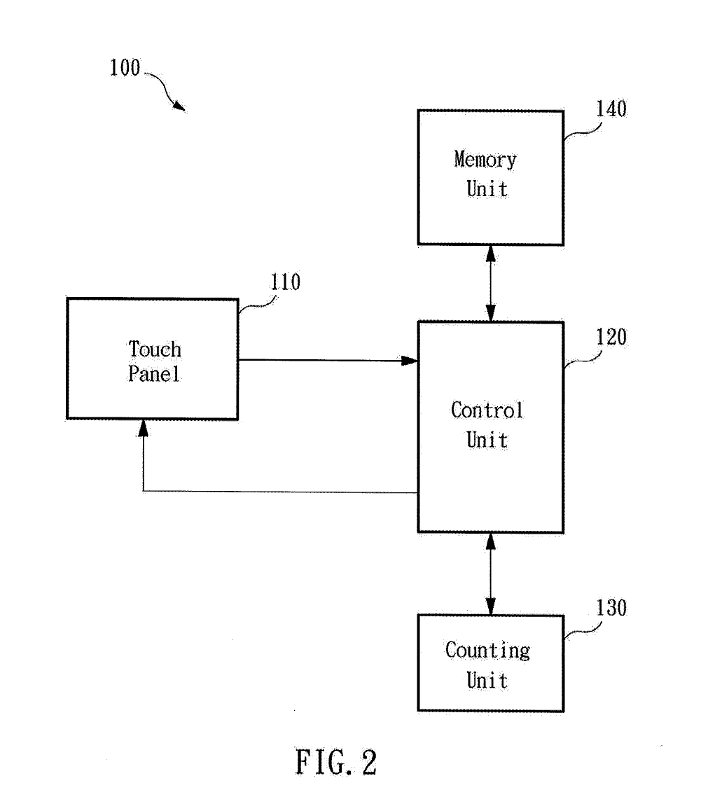

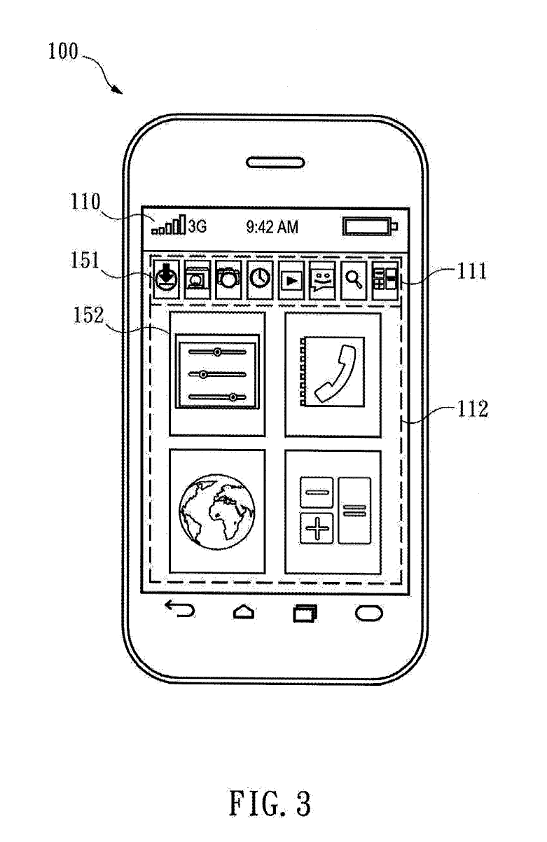

FIG. 2 is a block diagram of a display device according to an embodiment of the present invention. FIG. 3 is a top view of a display device according to one embodiment of the present invention. The display device 100 comprises a touch panel 110, a control unit 120, and a counting unit 130. The touch panel 110 may be used for display a first icon 151. The control unit 120 may electrically connect with the touch panel 110. When the control unit 120 executes a command corresponding to the first icon 151, the control unit 120 may send out a first activating signal. In another embodiment, when detecting that a command corresponding to the first icon is executed, the control unit 120 may send out a first activating signal. The counting unit 130, which is electrically connected with the control unit 120, may be used for counting the number of times the control unit 120 sends out the first activating signal.

The touch panel 110 further comprises a second icon 152. When executing a command corresponding to the second icon, the control unit 120 may send out a second activating signal.

The touch panel 100 may have a first display area 111 and a second display area 112. The first icon 151 may be displayed on the first display area 111, and the second icon 152 may be displayed on the second display area 112.

Preferably, the display device 100 further comprises a memory unit 140 to record the number of times the first activating signal and the second activating signal have been sent out by the control unit 120.

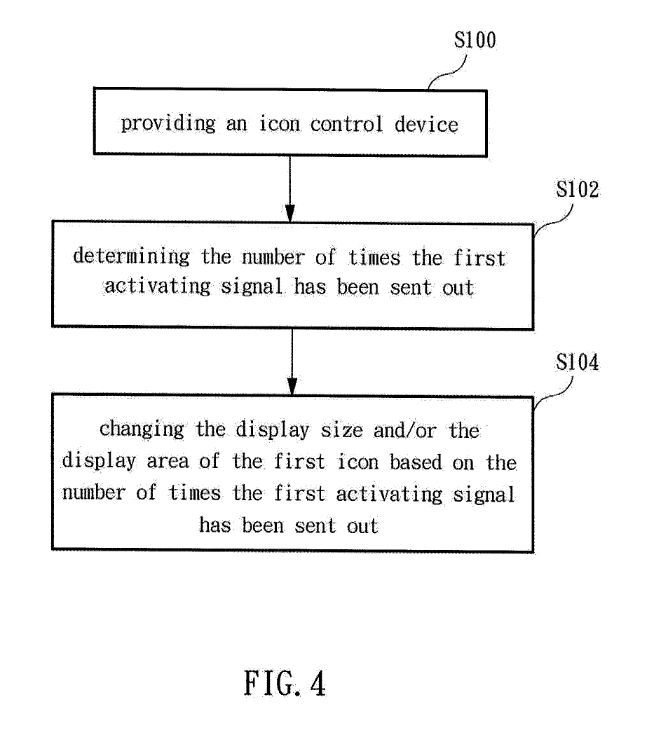

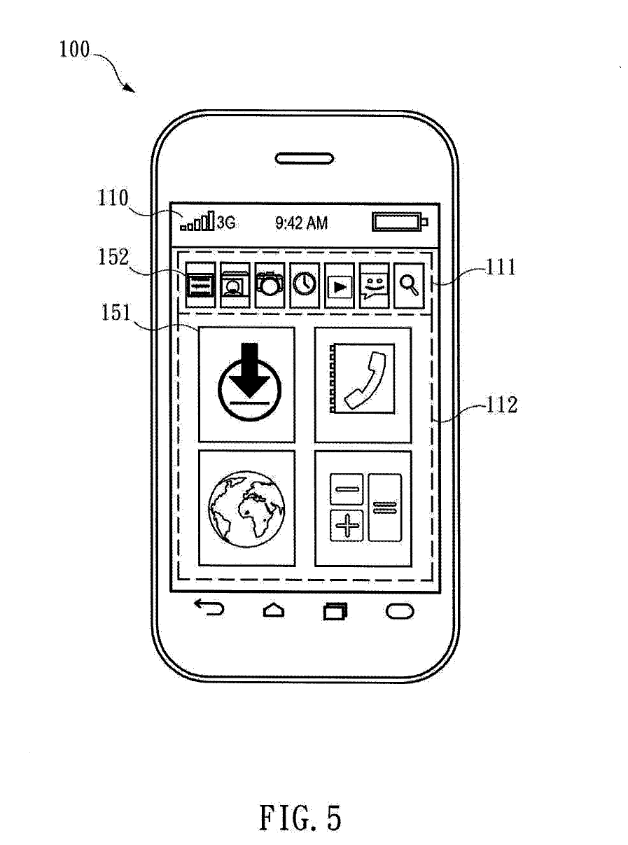

FIG. 4 is a flow chart of a control method according to an embodiment of the present invention. FIG. 5 is a diagram showing the change of the size and position of the first icon and the second icon. Please refer to FIGS. 2 and 3 together; the icon control method of the display device comprises the steps of following:

In step S100: a display device may be prepared. Please refer to FIGS. 2 and 3 together. In this step, the display device 100 is an electrical display device as shown in FIG. 2.

In step S102, the number of times the first activating signal has been sent out is determined. In this step, when the first icon 151 is touched by a user, the control unit 120 may execute a command corresponding to the first icon 151 and then sends a first activating signal to the counting unit 130. In another embodiment, when detecting a command corresponding to the first icon 151 is executed, the control unit 120 sends out a first activating signal to the counting unit 130.

Next, the control unit 120 may read the number of times the first activating signal has been sent out from the memory unit 140, and sends the data to the counting unit 130, so that the counting unit 130 may accumulate the number of times the first activating signal has been sent out, and sends the total number of times the first activating signal to the control unit 120. The control unit 120 may determine the number of times the first activating signal has been sent out.

In step S104, the display size and/or the display area of the first icon may be changed based on the number of times the first activating signal has been sent out. In this step, when detecting that a command corresponding to the second icon 152 is executed, the control unit 120 may send out a second activating signal. The control unit 120 may change the display area of the first icon 151 on the touch panel 110 based on a comparison of the number of times the first activating signal and the second activating signal have been sent out, and the control unit 120 may also determine whether to move the first icon 151 from the first display area 111 to the second display area 112, or move the second icon 152 from the second display area 112 to the first display area 111. In another embodiment, only the number of times the first activating signal has been sent out is used for determining whether to move the first icon 151 from the first display area 111 to the second display area 112.

Please refer to FIG. 5, the control unit 120 may base on the following conditions, but not limited thereto, for controlling: when the number of times the first activating signal has been sent out is larger than the number of times the second activating signal has been sent out, the control unit 120 may enlarge the display size of the first icon 151, or reduce the display size of the second icon 152. Also, the control unit 120 may move the first icon 151 from the first display area 111 to the second display area 112, or move the second icon 152 from the second display area 112 to the first display area 111. In another embodiment, when the number of times the first activating signal has been sent out is larger than a threshold value, the control unit 120 may enlarge the display size of the first icon 151 on the touch panel 110, and/or move the first icon 151 from the first display area 111 to the second display area 112.

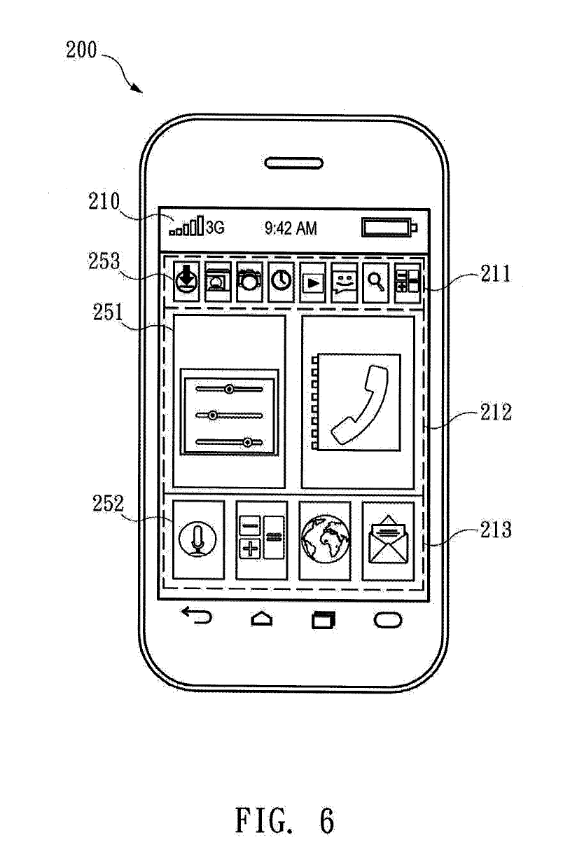

FIG. 6 is a top view of a display device according to another embodiment of the present invention. The touch panel 210 of the display device 200 may be divided into three display areas which are a first display area 211, a second display area 212, and a third display area 213. The first display area 211 may display the icons which are not often used in all of the icons. The second display area 212 may display the icons ranked top two in use. The third display area 213 may display the icons ranked from 3rd to 6th in use. The display size of the icon 251 on the second display area 212 of the touch panel 210 has the largest size compared to the sizes of the icons in other display areas. The display size of the icon 253 on the first display area 211 of the touch panel 210 has the smallest size compared to the sizes of the icons in other display areas. In addition, the display size of the icon 252 on the third display area 213 of the touch panel 210 is between the display size of the icon 251 on the second display area 212 and the display size of the icon 253 on the first display area 211. Therefore, by using the display device and an icon control method thereof shown in FIGS. 2 and 4, the icons on the touch panel 210 may have different display sizes based on the number of times they have been activated.

As mentioned above, the display device and an icon control method thereof may control the size of icons to have different display sizes based on the number of times they have been activated in order to achieve personalization. In the invention, based on the number of times the icon has been activated, a user may change the size and the display area of icons as he/she likes and thus to enhance the convenience in use. In addition, when the number of times an icon has been activated has reached a threshold value, the size of the icon may be enlarged and the icon may move to a display area on which the user may easily see and activate the icon in next time.

Although the present invention is disclosed through the embodiments, the embodiments are not intended to limit the present invention. Equivalent replacements like variations and modifications made by any person skilled in the art without departing from the spirit and scope of the present invention shall still fall within the protection scope of the present invention.

1. A display device, comprising:
a touch panel, used for displaying a first icon;
a control unit, electrically connecting with the touch panel and used for sending out a first activating signal when the control unit executes a command corresponding to the first icon; and
a counting unit, electrically connecting with the control unit and used for counting number of times the control unit sends out the first activating signal,
wherein the control unit controls a display size of the first icon on the touch panel based on the number of times the control unit sends out the first activating signal.

2. The display device of claim 1, wherein the control unit enlarges the display size of the first icon on the touch panel when the number of times the control unit sends out the first activating signal is larger than a threshold value.

3. The display device of claim 1, wherein the touch panel comprises a first display area and a second display area, the first icon is displayed on the first display area, and the control unit determines whether to move the first icon to the second display area based on the number of times the control unit sends out the first activating signal.

4. The display device of claim 1, wherein the touch panel further comprises a second icon, when the control unit executes a command corresponding to the second icon, the control unit sends out a second activating signal, and the control unit controls the display size of the first icon or the second icon on the touch panel based on the number of times the first activating signal and the second activating signal have been sent out.

5. The display device of claim 4, wherein the control unit enlarges the display size of the first icon or reduces the display size of the second icon when the number of times the control unit sends out the first activating signal is larger than that of the second activating signal.

6. The display device of claim 4, wherein the touch panel comprises a first display area and a second display area, the first icon is displayed on the first display area and the second icon is displayed on the second display area, and when the number of times the control unit sends out the first activating signal is larger than that of the second activating signal, the control unit moves the second icon from the second display area to the first display area.

7. An icon control method, applied to a display device having a touch panel on which a first icon is displayed, a control unit, and a counting unit, the method comprising steps of:
sending out a first activating signal when detecting a command corresponding to the first icon being executed by the control unit;
counting number of times the first activating signal has been sent out; and
changing the display size of the first icon on the touch panel based on the number of times the first activating signal has been sent out.

8. The method of claim 7, further comprising a step of: enlarging the display size of the first icon on the touch panel when the number of times the first activating signal has been sent out is larger than a threshold value.

9. The method of claim 7, wherein when the touch panel further displays a second icon, the method further comprising steps of: sending out a second activating signal when detecting a command corresponding to the second icon being executed by the control unit; changing the display size of the first icon or the second icon on the touch panel based on the number of times the first activating signal and the second activating signal have been sent out.

10. The method of claim 9, further comprising a step of: when the number of times the first activating signal has been sent out is larger than the second activating signal, enlarging the display size of the first icon or reduces the display size of the second icon by the control unit.

11. The method of claim 7, wherein when the touch panel further comprises a first display area and a second display area, the method further comprising a step of: determining whether to move the first icon from the first display area to the second display area based on the number of times the first activating signal has been sent out.

12. The method of claim 11, further comprising a step of: moving the first icon from the first display area to the second display area when the number of times the first activating signal has been sent out is larger than a threshold value.

13. The method of claim 7, wherein when the touch panel displays a second icon and further comprises a first display area and a second display area, and the first icon is displayed on the first display area and the second icon is displayed on the second display area, the method further comprising: sending out a second activating signal when a command corresponding to the second icon is executed by the control unit, and determining whether to move the first icon from the first display area to the second display area, or move the second icon from the second display area to the first display area based on the number of times the first activating signal and the second activating signal have been sent out.

14. The method of claim 13, further comprising a step of: moving the first icon from the first display area to the second display area when the number of times the first activating signal has been sent out is larger than that of the second activating signal.

15. The method of claim 13, further comprising a step of: moving the second icon from the second display area to the first display area when the number of times the first activating signal has been sent out is larger than that of the second activating signal.

16. An icon control method, applied to a display device having a touch panel on which a first icon is displayed, a control unit, and a counting unit, and the touch panel further comprising a first display area and a second display area, and the first icon is displayed on the first display area, the method comprising steps of:
sending out a first activating signal when detecting a command corresponding to the first icon being executed by the control unit;
counting number of times the first activating signal has been sent out; and
determining whether to move the first icon from the first display area to the second display area based on the number of times the first activating signal has been sent out.

17. The method of claim 16, further comprising a step of: moving the first icon from the first display area to the second display area when the number of times the first activating signal has been sent out is larger than a threshold value.

18. The method of claim 16, wherein when the touch panel displays a second icon displayed on the second display area, the method further comprising steps of: sending out a second activating signal when detecting a command corresponding to the second icon being executed by the control unit; determining whether to move the first icon from the first display area to the second display area, or move the second icon from the second display area to the first display area based on the number of times the first activating signal and the second activating signal have been sent out.

19. The method of claim 18, further comprising a step of: moving the first icon from the first display area to the second display area when the number of times the first activating signal has been sent out is larger than that of the second activating signal.

20. The method of claim 18, further comprising a step of: moving the second icon from the second display area to the first display area when the number of times the first activating signal has been sent out is larger than that of the second activating signal.
